(19) United States
(12) Patent Application Publication
(10) Pub. No.: US 2002/0021928 A1
(43) Pub. Date: Feb. 21, 2002

(54) Paper Guide

(76) Inventor: Uwe Gerhard Angst, Jockgrim (DE)

Correspondence Address: Lawrence P. Kessler, Patent Department, NexPress Solutions LLC, 1447 St. Paul Street, Rochester, NY, 14653-7103, US

(21) Appl. No.: 09/850,457

(22) Filed: May 7, 2001

(30) Foreign Application Priority Data
May 17, 2000 (DE) 100 24 206.5

(51) Int. Cl. B41J 5/08; B41J 5/10

(52) U.S. Cl. 400/492

(57) ABSTRACT

The invention pertains to a paper guide (1) consisting of shape parts (2), particularly for curves.

A paper guide (1) of such a kind can be manufactured in a non-expensive way and with high precision and can be equipped in a versatile way, whereby the shape parts (2) are made from pressed cord profiles (3).

### DESCRIPTION

The invention pertains to a paper guide consisting of shape parts, particularly for curves.

Paper guides of this kind can be found in numerous paper processing machines, particularly in printing machines and machines that further process prints. There are particularly high requirements for clean guiding and thus for higher precision of the parts when separate sheets of paper have to be guided. When electrostatic methods of printing are used, there is an additional requirement that the electrostatic charges have to be removed. However, such charges can be generated also through friction in products using other methods and must be also eliminated.

Until now, such paper guides were made of sheet metal. However, especially when the sheet metal had to be bent in order to manufacture curved parts, there was a problem, particularly for fast running machines, that the necessary high precision often could not be achieved. Above all, the processing through bending with minimal changes in the surrounding conditions, as for instance material inhomogeneities, and particularly regarding the formation of the curves, was leading to deviations from the measurements and consequently to high uneconomic use of spacing material.

A further disadvantage of the sheet metal parts was that the introduction of fastening elements, holding surfaces, or changes in the width of the paper paths could not be done in a simple way and often required welded connections, which are expensive and can not be made with great precision. Since mostly steel had to be used for sheet metal constructions of this kind, the components were also too weighty, which is undesirable.

One attempt to solve the above mentioned problems was to manufacture above all the shape parts for the curved areas from plastic materials. In this way, admittedly, it was possible to get better results than with shape parts made of sheet metal; however, this attempt to find a solution led to impasse. On the one hand, the manufacturing of such plastic parts required the use of very expensive forming tools, and, on the other hand, the plastic parts had to be covered with a metal surface, for example by means of chromium-plating, in order to eliminate the above mentioned electrostatic charges. The manufacturing of this surface made the parts additionally more expensive; it also did not satisfy the high mechanical requirements and the surface was wearing out with its use. In this way the needs for repairing the machine increased. Furthermore, the plastic material often was not sufficiently stable.

Therefore, the task of the present invention is to offer a paper guide made of shape parts that do not show the above mentioned disadvantages, are not expensive, and can be formed in many ways.

According to the present invention, this task is solved by manufacturing the shape parts from pressed cord profiles.

These shape parts have the advantage that they can be manufactured with less tools costs than those made of plastic materials and with less labor costs and considerably higher precision than the sheet metal shape parts. They show high stability and stiffness, high friction resistivity of the top surface layer, and good electrostatic properties. In the process of their manufacturing, a high level of repetitive precision can be achieved, whereby small tolerances are possible. A particularly advantageous feature is the large leeway in forming the pressed cord profiles because all kinds of fastening options, various strengths and shapes of materials as well as any equipment surfaces can be incorporated already in the pressed cord form. In this way, a shape profile in the form of bars is available, which can be lengthened to the desired length and does not require large further processing. As a rule, it is sufficient only to mill out the rollers for guiding the paper. The shape parts can be inserted at many locations along the paper path and can be fastened in different ways. Furthermore, it is possible to manufacture forms that can be easily mounted and adjusted.

The above mentioned arrangement as well as other arrangements that are made possible by the present invention will be discussed subsequently on the basis of several forms of implementation.

It has been proved that it is very advantageous to manufacture the shape parts from aluminum pressed cords profiles. In this way, lower weight and above all the required electrostatic properties can be achieved in a satisfactory way. The running properties of the paper and the useful life of the form parts can be further improved by processing the surfaces of the shape parts in such a way that these surfaces be smooth, hard, and friction resistant. Examples of such finishing processing of the surfaces are anodizing, tuffram, and hard cotting. These surfaces can be manufactured inexpensively and are considerably friction resistant than the coatings of plastic parts or those made by chroming.

One very advantageous implementation suggests that the shape parts have fastening elements running in the direction of the pressed cords. These fastening elements can be built in for fastening the shape parts to the machine or the functional components to the shape parts. It is particularly expedient to build the fastening element as screw channels, whereby these screw channels can be built both for accepting the screws running in the direction of the pressed cords and for accepting those running crosswise to the direction of the pressed cords. The last mentioned implementation has the advantage that the positioning of functional elements is possible at any place along such a screw channel. To this purpose it is possible to add additional stop surfaces that also stretch themselves in the direction of the pressed cords. The functional elements can also be hold by T-shaped sheet metal elements fastened to the screw channels. Examples for such functional elements are the bearings, e.g. the bearings of the rollers for guiding the paper.

Another advantageous implementation suggests that the shape parts have stiffening ribs running in the direction of the pressed cords; these ribs bring higher level of stiffness and strength and prevent the emergence of swinging. It is particularly appropriate to introduce stiffening ribs in the area where there are fastening elements fixing the shape parts to the machine because these ribs render a high level of stability to the structural components.

Also changes in the width of the paper-guiding path can be easily incorporated in the shape parts. For example, changes of this kind can consist in narrowings, which can be arranged in the direction of guiding the paper before the paper-guiding rollers. It is also appropriate to incorporate widenings in the form of steps into the form parts between the narrowings and the paper-guiding rollers in order to achieve secure guiding of the paper in the process of transition from guiding through the sides of the paper-guiding path to guiding through the paper-guiding rollers.

In another implementation, which is based on the possibility of opening a paper-guiding path, the paper guide is formed by two paper-guiding parts, whereby one of them is fixed on the machine and the other one has been made to fold open by means of a hinge and a lock. In this way, the paper-guiding path can be accessed without problems, for instance when it is necessary to remove a jam or to treat a smearing. The shape form fixed on the machine can be fastened to the machine by means of a three-point fastening element, which is mounted on the opposite side of the paper-guiding path.

A many-sided use of the shape parts is also possible, whereby they are constructed in such a way that they could be used at many places in the machine with the fastening elements built in a way that permits several fastenings. For example, if the shape parts are built like inside and outside curved dish, then the paper guiding of a given machine can implemented through the complete or predominant use of these two shape parts, constructed according the present invention

The possibilities that the manufacturing of the shape parts from pressed cord profiles have been enumerated here as examples only; many other advantageous implementations are also conceivable.

The invention will be discussed further on the basis of the implementation examples shown in the drawings. They show

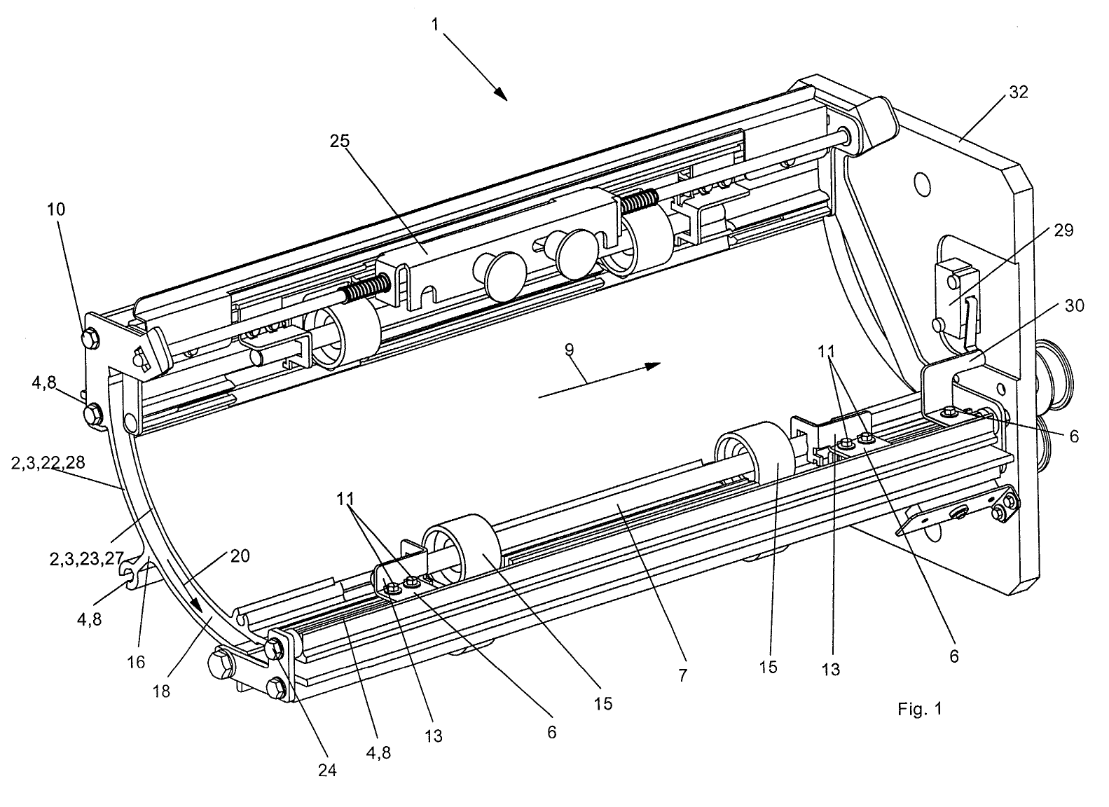

FIG. 1 a paper guide shown in a perspective view

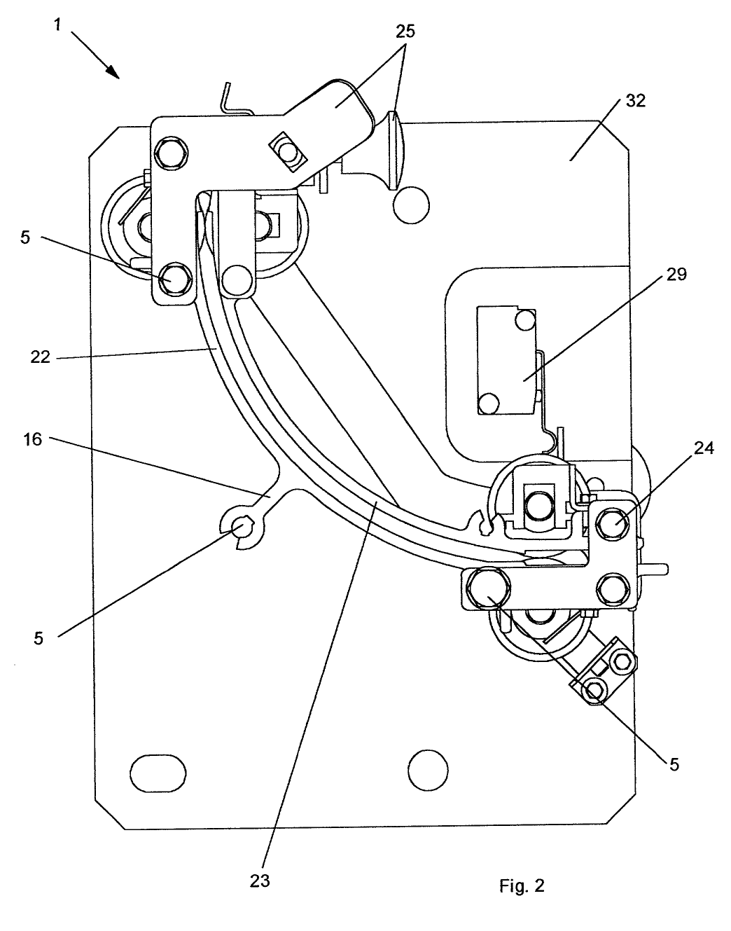

FIG. 2 a paper guide shown in a side view

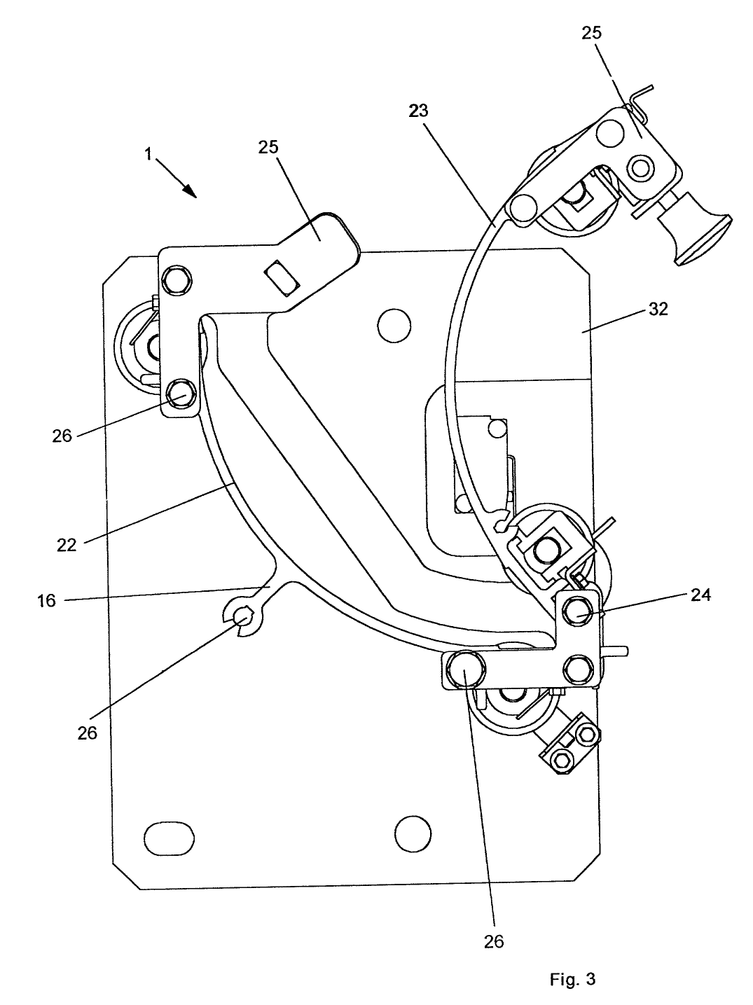

FIG. 3 an open-folded paper guide

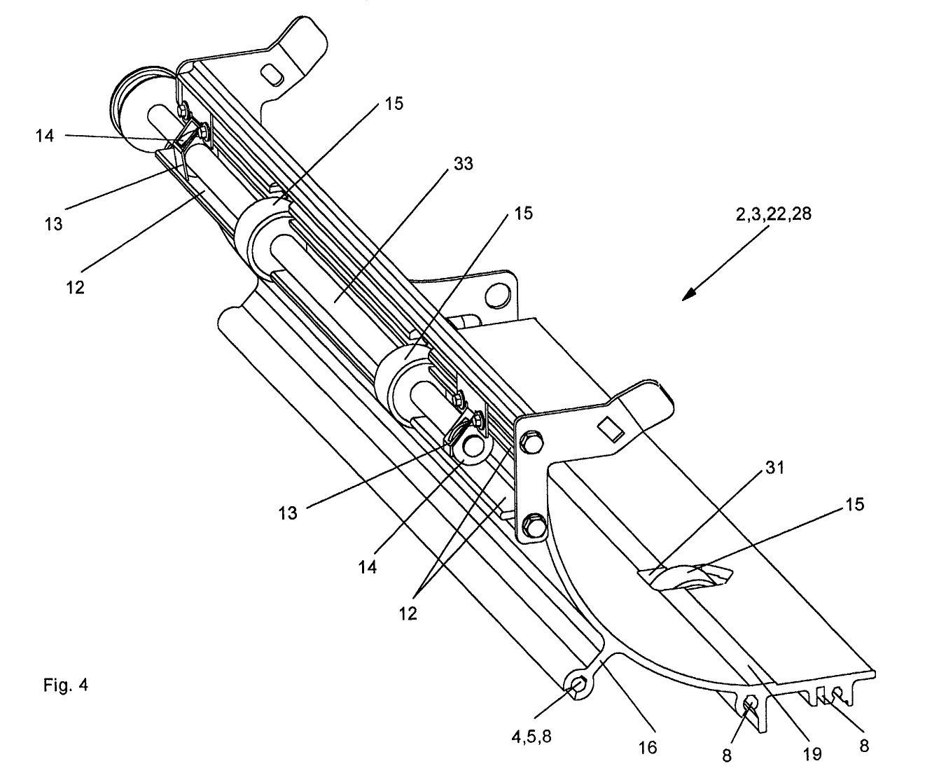

FIG. 4 an outside-curved dish

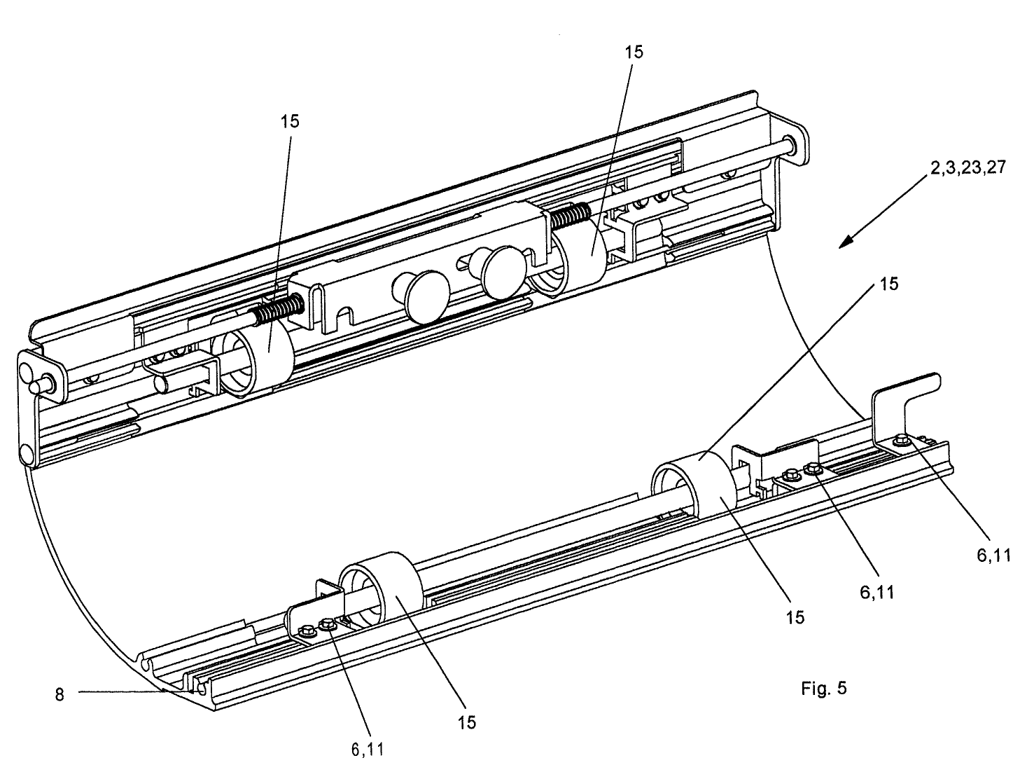

FIG. 5 an inside-curved dish

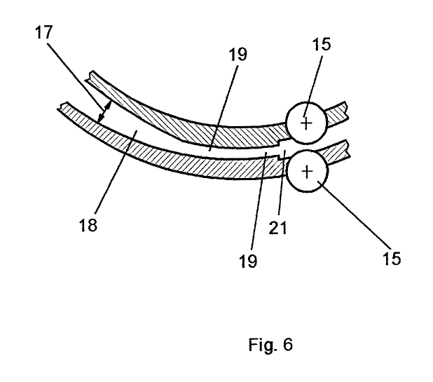

FIG. 6 a separate component of the paper-guiding path

FIG. 1 shows a paper guide in a perspective view. Shape parts 2 serve as a constructive basis, which is built as pressed cord profile 3. The direction of the pressed cords 9 lies crosswise to the paper-guiding direction 20 of the paper-guiding path 18. There are two shape parts 2—one shape part 22, which is fastened on the machine and forms the outward curve dish 28 of the paper-guiding path 18 and another shape part 2, which is constructed as open-folding shape part 23 and forms the inward curve dish 27. It goes without saying that the fastenings and the functions can be built also in other configurations. The shape parts 2 are manufactured in the form of bars in the direction of the pressed cords 9, they are lengthened to length that is necessary for them to be built in and then, if necessary, are supplied with millings 31 and/or are subjected to a surface treatment. All necessary fastening elements 4 have been already inserted into this pressed cord profile 4:

These are the fastenings 5 for the fastening on the machine, which, for example, is shown here as a side wall 32 of the machine. This fastening is effected by means of screw channels 8, which are intended for the screws 10, which run in the direction 9 of the pressed cords. For example, in this way, a lock 25 is fixed. The fastening 5 to the side wall 32 of the machine is done by means of screws 10, which run in the direction 9 of the pressed cords.

Furthermore, there are fastening elements 4 for the fastening 6 of the function elements 7. Here they are shown as paper-guiding rollers 15, which are fixed by means of T-shaped sheet metal elements 13 holding the bearing 14. The T-shaped sheet metal elements 13 are fixed in the screw channels 8 by means of screws 11, which run crosswise to the direction 9 of the pressed cords. An activation lever 30 for an end switch 29 is fastened in the same way. In this way or also by using the above-mentioned possibility, the shape parts 2 can be supplied with all necessary functional elements 7.

Further views and details are shown in the following figures.

FIG. 2 shows a paper guide 1 in a side view and FIG. 3 shows the same paper guide 1 in an open-folded state. Shape part 22 is fixed to the machine, here on the side wall 32, by means of fastenings 5. One of those fastenings 5 is positioned in such a way that it forms at the same time a stiffening rib 16. The fastenings 5 are constructed as a three-point fastening 26. An open-foldable shape part 23 is fixed on the shape part 22 by means of a hinge 24, whereby the open-foldable shape part can, as it is shown in FIG. 3, be opened, whereby the lock 25 gets open. Both parts of the lock 25 can be seen in FIG. 3

FIG. 4 shows in a perspective view the shape part 22, which is fixed on the machine, whereby the shape part 22 is shown as an outside-curved dish 28. Here it can be seen that how the paper-guiding rollers 15 are positioned by means of the bearings 14, whereby the bearings 14 are hold by T-formed metal sheets, which are fixed in the screw channels 8 by means of the screws 11. The bearings 14 lie on two stop surfaces 12 running at right angle. A shaft 33, which carries the two paper-guiding rollers 15 (of course there can be also several of them), runs between the bearings 14. In order that the paper-guiding rollers 15 be able to reach in the paper-guiding path 18, the millings 31 of the shape parts 2 have been supplied. For good guiding of the paper in this area, narrowings 19 and widenings in the form of steps 21 have been formed on the shape parts 2. This is illustrated further below in greater details.

FIG. 5 shows an inside-curved dish 27 in a perspective view. The fastenings 6 of the functional elements, as for example the paper-guiding rollers 15, can be recognized here.

FIG. 6 shows a separate component of the paper-guiding path 18 with a narrowing 19, which is mounted before the guiding of the paper by the paper-guiding rollers 15 in order to guide the paper exactly to these rollers 15. A widening in the form of steps 21 is positioned between the narrowing 19 and the paper-guiding rollers 15, whereby the clean guiding of the papers by means of the narrowings 19 is maintained and ensured.

FIG. 6 also illustrates how it is possible—by manufacturing the shape parts 2 from pressed cord profiles 3 according to the present invention—to adjust the width 17 of the paper-guiding path 18 in different ways, whereby the wall thickness of the shape parts 2 in contrast to the case when these shape parts are manufactured from sheet metal - can be varied as desired. The variations of the wall thickness performed in this way allow to use more strongly stabilized areas or to heap more material at places subjected to high strain, as for instance at the fastenings 5 or 6.

The drawings show only one implementation example with several realizations and further developments. It goes without saying that the shape parts 2 manufactured from pressed cord profiles 3 are not limited to the implementation of this kind. Also straight led paper-guiding paths 18 or any desired form of paper-guiding paths 18 can be manufactured in this way and can be supplied with the necessary fastening elements 4 as well as with other elements and implementations.

### Reference to the List of Drawings

1. Paper guide

2. Shape parts

3. Pressed cord profile

4. Fastening elements

5. Fastening onto the machine

6. Fastening of functional elements

7. Functional elements, e.g. paper guide

8. Screw channels

9. Direction of the pressed cords

10. Screws running in the direction of the pressed cords

11. Screws running crosswise to the direction of the pressed cords

12. Stop surfaces used for fastening the functional elements

13. T-shaped metal sheet

14. Bearing

15. Paper-guiding rollers

16. Stiffening ribs

17. Width of the paper-guiding path

18. Paper-guiding path

19. Narrowings

20. Direction of the paper guiding

21. Widenings in the form of steps

22. Shape part fixed on the machine

23. Open-foldable shape part

24. Hinge

25. Lock

26. Three-point fastening element

27. Inward curve dish

28. Outward curve dish

29. End switch

30. Activating lever for the end switch

31. Milling for the paper-guiding rollers

32. Side wall of the machine

33. Shaft

1. Paper guide (1) consisting of shape parts (2), particularly for curves, with the characteristics that the shape parts (2) are made of pressed cord profiles (3).

2. Paper guide according to claim 1, with the characteristics that the shape parts (2) are made of aluminum pressed cord profiles.

3. Paper guide according to claim 1 or claim 2, with the characteristics that the shape parts (2) have their surface treated in such a way that the surface is smooth, hard, and friction resistant.

4. Paper guide according to claims 1, 2, or 3 with the characteristics that the shape parts (2) have fastening elements (4) running in the direction (9) of the pressed cords.

5. Paper guide according to claim 4, with the characteristics that the fastening elements (4) for the fastening (5) of the shape parts (2) are mounted on the machine.

6. Paper guide according to claims 4 or 5, with the characteristics that the fastening elements (4) for the fastening (6) of the functional elements (7) are mounted on the form parts (2).

7. Paper guide according to claims 4, 5, or 6, with the characteristics that the fastening elements (4) are implemented as screw channels (8).

8. Paper guide according to claim 7, with the characteristics that the screw channels (8) are built to accept the screws (10) running in the direction (9) of the pressed cords.

9. Paper guide according to claims 7, or 8, with the characteristics that the screw channels (8) are built to accept the screws (10) running crosswise to the direction (9) of the pressed cords.

10. Paper guide according to claims 1 through 9, with the characteristics that stop surfaces (12) for fastening the functional elements (7) are provided.

11. Paper guide according to claim 10, with the characteristics that the functional elements (7) are hold by T-formed metal sheets (13) fastened to the screw channels (8).

12. Paper guide according to claims 10, or 11, with the characteristics that the functional elements (7) are the bearings (14).

13. Paper guide according to claim 12, with the characteristics that the bearings (14) are those of the paper-guiding rollers (15).

14. Paper guide according to claims 1 through 13, with the characteristics that the shape parts (2) have stiffening ribs (16) in the direction of the pressed cords ((9).

15. Paper guide according to claim 14, with the characteristics that the stiffening ribs (16) are mounted on the machine in the area of the fastenings (5).

16. Paper guide according to claims 1 through 15, with the characteristics that the changes in the width (17) of the paper-guiding path (18) are incorporated in the shape parts (2).

17. Paper guide according to claim 16, with the characteristics that the narrowings (19) are those that are mounted in the direction (20) of paper guiding before the paper-guiding rollers (15).

18. Paper guide according to claim 17, with the characteristics that the widenings in the form of steps (21) are incorporated into the form parts (2) between the narrowings (19) and the paper-guiding rollers (15).

19. Paper guide according to claims 1 through 18, with the characteristics that it consists of two shape parts (22, 23); one of them (22) is mounted on the machine and the other one (23) is mounted as open folded by means of a hinge (24) and a lock (25).

20. Paper guide according to claim 19, with the characteristics that the shape part (22) is fastened on the machine by means of three-point fastening element (26), which is mounted at the opposite side of the paper-guiding path (18).

21. Paper guide according to claims 1 through 20, with the characteristics that the shape parts (2) are constructed in such a way that they can be used at several places in a given machine, whereby the fastening elements (4) are constructed in such a way that they allow several fastenings (5, 6).

22. Paper guide according to claims 1 through 21, with the characteristics that the shape parts (2) are constructed as inward (27) and outward (28) curved dishes..
